(19) United States
(12) Patent Application Publication
(10) Pub. No.: US 2026/0253423 A1
(43) Pub. Date: Aug. 27, 2026

(54) OBSTACLE RECOGNITION METHOD AND DRIVING ROBOT

(71) Applicant: LG ELECTRONICS INC., Seoul (KR)

(72) Inventors: Youngtak NA, Seoul (KR); Seoyoon SON, Seoul (KR); Woohyoung SHIN, Seoul (KR); Youngyeon SEO, Seoul (KR); Hyukjoon LEE, Seoul (KR)

(73) Assignee: LG ELECTRONICS INC., Seoul (KR)

(21) Appl. No.: 18/881,997

(22) PCT Filed: Nov. 16, 2022
(86) PCT No.: PCT/KR2022/018073

§ 371 Date: Jan. 7, 2025

(30) Foreign Application Priority Data
Jul. 21, 2022 (KR) 10-2022-0090560

(51) Int. Cl. G06V 20/58; G05D 1/246; G05D 1/622; G05D 109/10; G05D 111/10; G06T 3/4038

(52) U.S. Cl. CPC G06V 20/58; G05D 1/246; G05D 1/622; G06T 3/4038; G05D 2109/10; G05D 2111/10

(57) ABSTRACT

This obstacle recognition method comprises the steps of: receiving a captured image from a camera; distinguishing a floor area from an obstacle on the captured image; generating a top-view image by removing the perspective of the captured image; designating a plurality of closest datum points on the top-view image; extracting a front surface of the obstacle by performing a linear search while rotating at each of the plurality of datum points; and selecting only an overlapping portion from the front surface of the obstacle extracted from the plurality of datum points as a final front surface of the obstacle. According to the obstacle recognition method, obstacles can be searched for at low cost.

### TECHNICAL FIELD

The present disclosure relates to an obstacle recognition method for determining an obstacle in an image by capturing the image, and a driving robot.

### BACKGROUND

To take charge of a portion of factory automation, robots have been developed for industrial use. Recently, the application range of robots has been further expanded, and robots that can be used in daily life as well as medical robots and aerospace robots are being developed.

Among industrial robots, robots that perform precise assembly work repeatedly perform the same operations and repeat the operations without encountering unexpected situations at a predetermined position, so that automation using the robots has been proceeded.

However, a transportation area including a traveling area (i.e., a driving area) where occurrence or non-occurrence of unexpected situations can be determined, has not yet been actively commercialized with robots. However, recently, as performance of sensors that recognize the surroundings has improved and computer technology that can quickly process the recognized information has evolved, the number of driving robots has rapidly increased.

Industrially, robots that are in charge of transportation functions have attracted attention and competition in robot technology is intensifying day by day. In addition to robots that transport bulky or large articles, there is a growing need for robots that perform services to transport small articles to destinations.

In case of the driving robot, even when a basic map is equipped, it should travel while searching for an obstacle not on the map. Accordingly, the driving robot travels while searching for the obstacle on a traveling path using various sensors such as a LiDAR, a radar, a depth camera, and a proximity sensor.

However, as a travel speed increases, a recognition rate of the sensor may decrease. Further, the recognition rate is low for an obstacle whose vertical level from the floor is not high.

### SUMMARY

### Technical Problem

The present disclosure is to provide an obstacle recognition method for determining an obstacle in an image by capturing an image, and a driving robot.

### Technical Solutions

Provided is a method for recognizing an obstacle including receiving a captured image from a camera, distinguishing a floor area from an obstacle on the captured image, generating a top view image by removing perspective of the captured image, specifying a plurality of datum points at the shortest distance on the top view image, extracting an obstacle front surface by performing linear search while rotating at each of the plurality of datum points, and selecting only an overlapping portion of the obstacle front surfaces extracted from the plurality of datum points as a final obstacle front surface.

The extracting of the obstacle front surface may include connecting a straight line from each datum point to a pixel of an outer periphery of the top view image, and when the straight line overlaps an obstacle on the top view image, extracting the straight line as the obstacle front surface.

The pixel of the outer periphery of the top view image may include pixels on lines extending from a lower left end to an upper left end, an upper right end, and then to a lower right end of the top view image.

The plurality of datum points may be distributed at least to a left side and a right side from a location of the camera.

A spacing between the datum points may be great when a size of the top view image is great, and may be small when the size of the top view image is small.

The specifying of the plurality of datum points may include generating a segmentation map obtained by extracting a boundary between a floor area and an obstacle from the top view image, and specifying the plurality of datum points at a lower end of a floor area of the segmentation map.

The camera may include a first camera that captures an area located ahead to provide a first captured image, and a second camera that captures an area located below to provide a second captured image, and the top view image may be generated by synthesizing the first captured image and the second captured image after removing the perspective from each image.

A lower portion of the first captured image may overlap an upper portion of the second captured image.

The generating of the top view image may include converting the captured image into the top view image using an inverse perspective mapping (IPM) technique.

The top view image may be generated by discarding an upper portion not including the floor area of the captured image.

The distinguishing of the floor area from the obstacle may further include removing a shadow and light reflection on the captured image.

The method may further include adding the selected obstacle to an existing map or a map obtained via another sensor.

Provided is a driving robot including a main body including a driving structure, a camera that captures an image in a travel direction, and a controller that recognizes an obstacle via the captured image captured by the camera and controls the driving structure, wherein the controller distinguishes a floor area from the obstacle on the captured image, generates a top view image by removing a perspective of the captured image, extracts a plurality of datum points at the shortest distance on the top view image, extracts an obstacle front surface by performing linear search while rotating at each of the plurality of datum points, selects only an overlapping portion of the obstacle front surfaces extracted from the plurality of datum points as an actual obstacle, and adds the selected obstacle to an existing map or a map obtained via another sensor, sets a traveling path based on the map with the selected obstacle added, and controls the driving structure to move along the traveling path.

The controller may connect a straight line from each datum point to a pixel of an outer periphery of the top view image, and when the straight line overlaps an obstacle on the top view image, extract the straight line as the obstacle front surface.

The camera may include a first camera that captures an area located ahead to provide a first captured image, and a second camera that captures an area located below to provide a second captured image, and the top view image may be generated by synthesizing the first captured image and the second captured image after removing the perspective from each image.

### Advantageous Effects

According to the obstacle search method of the present disclosure, the obstacle located on the floor without having the high vertical level may be recognized.

Because the obstacle may be recognized at a lower cost than the sensor, it may be applied to various types of driving robots.

Effects obtainable from the present embodiments are not limited by the above mentioned effects, and other unmentioned effects can be clearly understood from the above description by those having ordinary skill in the technical field to which the present disclosure pertains.

### BRIEF DESCRIPTION OF THE DRAWINGS

FIG. 1 is a diagram illustrating a cloud system based on a 5G network according to an embodiment of the present disclosure.

FIG. 2 is a block diagram illustrating appearance of a driving robot according to an embodiment of the present disclosure.

FIG. 3 is a diagram illustrating a robot control system according to an embodiment of the present disclosure.

FIG. 4 is a perspective view illustrating a driving robot according to an embodiment of the present disclosure.

FIG. 5 is a flowchart according to an embodiment of an obstacle recognition method of the present disclosure.

FIG. 6 is a view illustrating capturing ranges of cameras according to an embodiment of a driving robot of the present disclosure.

FIG. 7 is a diagram illustrating captured images captured by cameras according to an embodiment of a driving robot of the present disclosure.

FIG. 8 is a diagram illustrating an image obtained by extracting a free space of a floor from captured images in FIG. 7 according to an embodiment of an obstacle recognition method of the present disclosure.

FIG. 9 is a view illustrating a hole filter technique for removing a portion misrecognized as an obstacle from a captured image according to an embodiment of an obstacle recognition method of the present disclosure.

FIGS. 10 and 11 are diagrams illustrating a process of generating top view images according to an embodiment of an obstacle recognition method of the present disclosure.

FIG. 12 is a diagram illustrating an image in which a top view image according to an embodiment of an obstacle recognition method of the present disclosure is divided into an obstacle and a floor and reflected in a map.

FIG. 13 is a top view illustrating a state of an actual space.

FIG. 14 is a diagram illustrating a method of extracting an actual obstacle front surface in a vision LiDAR method according to an embodiment of an obstacle recognition method of the present disclosure.

FIG. 15 is a diagram illustrating a linear search method when there is one datum point.

FIG. 16 is a diagram illustrating a state in which an extracted obstacle front surface is reflected in a map according to an embodiment of an obstacle recognition method of the present disclosure.

### BEST MODEL

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element may be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A robot is a machine device capable of automatically performing a certain task or operation. The robot may be controlled by an external control device or may be embedded in the control device. The robot may perform tasks that are difficult for humans to perform, such as repeatedly processing only a preset operation, lifting a heavy object, performing precise tasks or a hard task in extreme environments.

In order to perform such tasks, the robot includes a driver such as an actuator or a motor, so that the robot may perform various physical operations, such as moving a robot joint.

Industrial robots or medical robots having a specialized appearance for specific tasks due to problems such as high manufacturing costs and dexterity of robot manipulation were the first to be developed.

Whereas industrial and medical robots are configured to repeatedly perform the same operation in a designated place, mobile robots have recently been developed and introduced to the market. Robots for use in the aerospace industry may perform exploration tasks or the like on distant planets that are difficult for humans to directly go to, and such robots have a driving function.

In order to perform the driving function, the robot has a driver, wheel(s), a frame, a brake, a caster, a motor, etc. In order for the robot to recognize the presence or absence of surrounding obstacles and move while avoiding the surrounding obstacles, an evolved robot equipped with artificial intelligence has recently been developed.

Artificial intelligence refers to a technical field for researching artificial intelligence or a methodology for implementing the artificial intelligence. Machine learning refers to a technical field for defining various problems handled in the artificial intelligence field and for researching methodologies required for addressing such problems. Machine learning is also defined as an algorithm that improves performance of a certain task through continuous experience.

An artificial neural network (ANN) is a model used in machine learning, and may refer to an overall model having problem solving ability, which is composed of artificial neurons (nodes) that form a network by a combination of synapses. The artificial neural network (ANN) may be defined by a connection pattern between neurons of different layers, a learning process of updating model parameters, and an activation function of generating an output value.

The artificial neural network (ANN) may include an input layer and an output layer, and may optionally include one or more hidden layers. Each layer includes one or more neurons, and the artificial neural network (ANN) may include a synapse that interconnects neurons and other neurons.

In the artificial neural network (ANN), each neuron may output a function value of an activation function with respect to input signals received through synapses, weights, and deflection.

A model parameter may refer to a parameter determined through learning, and may include the weight for synapse connection and the deflection of neurons. In addition, the hyperparameter refers to a parameter that should be set before learning in a machine learning algorithm, and includes a learning rate, the number of repetitions, a mini-batch size, an initialization function, and the like.

The purpose of training the artificial neural network (ANN) may be seen as determining model parameters that minimize a loss function according to the purpose of the robot or the field of use of the robot. The loss function may be used as an index for determining an optimal model parameter in a learning process of the artificial neural network (ANN).

Machine learning may be classified into supervised learning, unsupervised learning, and reinforcement learning according to learning methods.

Supervised learning refers to a method for training the artificial neural network (ANN) in a state where a label for learned data is given. Here, the label may refer to a correct answer (or a redundant value) that should be inferred by the artificial neural network (ANN) when the learned data is input to the artificial neural network (ANN). Unsupervised learning may refer to a method for training the artificial neural network (ANN) in a state where a label for learned data is not given. Reinforcement learning may refer to a learning method in which an agent defined in the certain environment learns to select an action or sequence of actions that may maximize cumulative compensation in each state.

Among artificial neural networks, machine learning implemented as a deep neural network (DNN) including a plurality of hidden layers is also referred to as deep learning, and deep learning is a part of machine learning. Hereinafter, machine learning is used in a sense including deep learning.

Artificial intelligence (AI) technology is applied to the robot, so that the robot may be implemented as a guide robot, a transport robot, a cleaning robot, a wearable robot, an entertainment robot, a pet robot, and an unmanned aerial robot, etc.

The robot may include a robot control module for controlling operation thereof, and the robot control module may refer to a software module or a chip implemented in hardware.

By means of sensor information obtained from various types of sensors, the robot may acquire state information of the robot, may detect (recognize) the surrounding environment and the object, may generate map data, may determine a driving path and a driving plan, may determine a response to user interaction, or may determine a necessary operation.

The robot may perform the above-described operations using a learning model composed of at least one artificial neural network (ANN). For example, the robot may recognize the surrounding environment and object using a learning model, and may determine a necessary operation using the recognized surrounding environment information or object information. Here, the learning model may be directly learned from the robot or learned from an external device such as an AI server.

In this case, whereas the robot may perform a necessary operation by directly generating a result using the learning model, the robot may also perform an operation by transmitting sensor information to an external device such as an AI server and receiving the resultant information generated thereby.

The robot may perform autonomous driving through artificial intelligence. Autonomous driving refers to a technique in which a movable object such as a robot may autonomously determine an optimal path by itself and may move while avoiding collision with an obstacle. The autonomous driving technique currently being applied may include a technique in which the movable object (e.g., a robot) may travel while maintaining a current driving lane, a technique in which the movable object may travel while automatically adjusting a driving speed such as adaptive cruise control, a technique in which the movable object may automatically travel along a predetermined path, and a driving technique in which, after a destination is decided, a path to the destination is automatically set.

In order to perform autonomous driving, the movable object such as the robot may include a large number of sensors to recognize data of the surrounding situation. For example, the sensors may include a proximity sensor, an illumination sensor, an acceleration sensor, a magnetic sensor, a gyro sensor, an inertial sensor, an RGB sensor, an infrared (IR) sensor, a fingerprint recognition sensor, an ultrasonic sensor, an optical sensor, a microphone, a Lidar, a radar, and the like.

The robot may perform autonomous driving not only based on information collected by sensors, but also based on image information collected by an RGBC camera and an infrared (IR) camera and sound information collected through a microphone. In addition, the robot may travel based on information received through a user input unit. Map data, position information, and information about peripheral situations may be collected through a wireless communication unit. The collected information is requisite for autonomous driving.

Map data may include object identification information for various objects disposed in a space where the robot moves. For example, the map data may include object identification information for fixed objects such as a wall and a door, and other object identification information for movable objects such as a flowerpot and a desk. In addition, the object identification information may include a name, a type, a distance, a location, etc.

Therefore, the robot may essentially include sensors, various input units, a wireless communication unit, and the like to collect data that may be learned by artificial intelligence, and may perform optimal operations by synthesizing various types of information. The learning processor for performing artificial intelligence may perform learning by being mounted in a controller embedded in the robot, may transmit the collected information to a server, may perform learning through the server, and may retransmit the learned result to the robot, so that the robot may perform autonomous driving based on the learned result.

A robot equipped with artificial intelligence may collect the surrounding information even in a new place to implement the entire map, and a large amount of information about a place of the major activity zone may be accumulated, so that the robot may perform more accurate autonomous driving.

The robot may include a touchscreen or a button to receive a user input, and may receive a command by recognizing a user's voice. In order to convert a voice input signal into a character string, the processor may obtain information about the intention corresponding to the user input using at least one of a speech to text (STT) engine for converting a voice input into a character string and a natural language processing (NLP) engine for obtaining information about the intention of natural language.

In this case, at least one of the STT engine and the NLP engine may include an artificial neural network (ANN) trained by a machine learning algorithm. In addition, at least one of the STT engine and the NLP engine may be trained by the learning processor, may be trained by the learning processor of the AI server, or may be trained by distributed processing of the trained results.

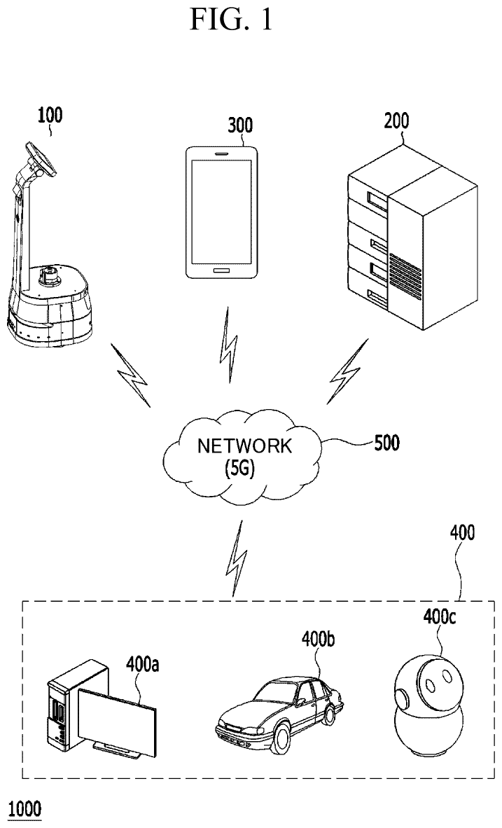

FIG. 1 is a diagram illustrating a cloud system 1000 based on a 5G network according to an embodiment of the present disclosure.

Referring to FIG. 1, the cloud system 1000 may include a driving robot 100, a mobile terminal 300, a robot control system 200, various devices 400, and a 5G network 500.

The driving robot 100 is a robot that transports goods (articles) from a departure point to a destination. The driving robot 100 can move directly from a logistics center to a destination. Alternatively, after the driving robot is loaded on a vehicle at the logistics center and is then delivered to the vicinity of the destination by the vehicle, the driving robot is unloaded from the vehicle and then moves to the destination.

In addition, the driving robot 100 may move articles to the destination not only outdoors but also indoors. The driving robot 100 can be implemented as an AGV, and the AGV may be a transport device that moves by a sensor, a magnetic field, a vision device, etc. on the floor.

The driving robot 100 may include a storage area for storing articles therein, the storage area may be divided into a plurality of partial storage areas to load various articles, and various types of articles may be placed in the partial storage areas. Accordingly, mixing of articles can be prevented.

The mobile terminal 300 may communicate with the driving robot 100 via the 5G network 500. The mobile terminal 300 may be a device carried by a user who installs a partition in the storage area to load articles, or may be a device carried by a recipient of the loaded articles. The mobile terminal 300 may provide information based on images, and the mobile terminal 300 may include mobile devices such as a mobile phone, a smartphone, a wearable device (e.g., a watch-type terminal, a glass-type terminal, an HMD).

The robot control system 200 may remotely control the driving robot 100 and respond to various requests of the driving robot 100. For example, the robot control system 200 may perform calculations using artificial intelligence (AI) based on the request from the driving robot 100.

In addition, the robot control system 200 may determine a movement path of the driving robot 100. When there is a plurality of destinations, the robot control system 200 may determine the order of the destinations when there are multiple destinations.

The various devices 400 may include a personal computer (PC) 400a, an autonomous vehicle 400b, a home robot 400c, etc. When the driving robot 100 arrives at the transport destination of the articles, the driving robot 100 can directly deliver the articles to the home robot 400c through communication with the home robot 400c.

The various devices 400 may be connected to the driving robot 100, the mobile terminal 300, the robot control system 200, etc., via the 5G network 500 by wire or wirelessly.

The driving robot 100, the mobile terminal 300, the robot control system 200, and various devices 400 are all equipped with 5G modules to transmit and receive data at a rate of 100 Mbps to 20 Gbps (or higher), so that large video files can be transmitted to various devices, and power consumption can be minimized by operating at low power. However, the transfer rate may be implemented differently depending on the embodiments.

The 5G network 500 may include a 5G mobile communication network, a short-range network, the Internet, etc., and may provide a communication environment for devices by wire or wirelessly.

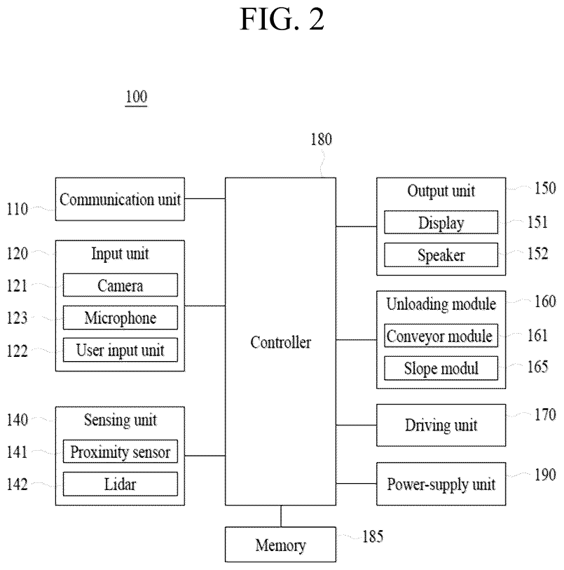

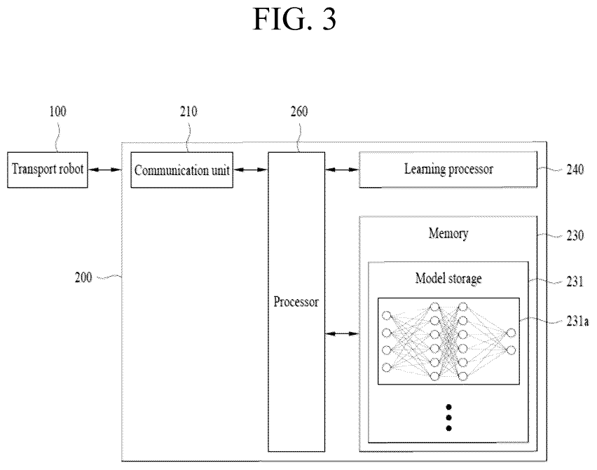

FIG. 2 is a block diagram illustrating appearance of the driving robot 100 according to an embodiment of the present disclosure. The driving robot 100 according to an embodiment of the present disclosure will be described with reference to FIGS. 3 to 5.

Referring to FIG. 2, the driving robot 100 may include a body including a storage area 50, and constituent components to be described later may be included in the body. The driving robot 100 may include a communication unit 110, an input unit 120, a sensor unit 140, an output unit 150, a memory 185, a wheel driving unit 170, a controller 180, and a power-supply unit 190. The constituent components shown in FIG. 2 are not always required to implement the driving robot 100, such that it should be noted that the driving robot 100 according to the present disclosure may include more or fewer components than the elements listed above.

The communication unit 110 may include a wired or wireless communication module capable of communicating with the robot control system 200.

As an optional embodiment, the communication unit 110 may be equipped with modules for GSM, CDMA, LTE, 5G, WLAN, Wi-Fi, Bluetooth, RFID, infrared communication (IrDA), ZigBee, and NFC communication.

The input unit 120 may include a user input unit 122 for receiving information from a user. As an optional embodiment, the input unit 120 may include a camera 121 for inputting an image signal, and a microphone 123 (hereinafter referred to as a “microphone”) for receiving an audio signal. Here, the camera 121 or the microphone 123 may be treated as a sensor, and a signal acquired from the camera 121 or the microphone 123 may be referred to as sensing data or sensor information.

The input unit 120 may acquire input data to be used when acquiring output data using learning data and a learning model for model learning. The input unit 120 may obtain unprocessed input data. In this case, the controller 180 may extract input feature points as preprocessing for the input data.

The camera 121 may be located in front to detect obstacles in front, and as shown in FIG. 3, a plurality of cameras 121 may be arranged to be different in angle. In more detail, the plurality of cameras 121 may have different capture directions, such as a camera for widely recognizing a front-view area and a camera for capturing a floor.

Alternatively, cameras with different functions may be provided. For example, a wide-angle camera, an infrared (IR) camera, etc. may be provided. The camera may serve as a sensor unit 140 for detecting surrounding objects.

The user input unit 122 may be provided with a touch panel overlapping with a button or a display 151. Alternatively, a user command may be input remotely through the communication unit 110. In this case, the user input unit 122 may include a PC 400 or a remote control device separately provided from the driving robot 100.

Since the user input unit 122 includes all methods capable of receiving user commands, the user input unit 122 can recognize user commands through voice recognition. That is, a voice recognition device that analyzes voice collected from the microphone 123 and extracts user commands can also serve as the user input unit 122.

The input unit 120 may include an article information input unit, and the article information input unit may receive information about the article's size, information about the article's weight, destination information, information about a transport requester, etc. At this time, the article information input unit may include a code reader.

The sensor unit 140 may obtain at least one of internal information of the driving robot 100, surrounding environment information of the driving robot 100, and user information using various sensors.

At this time, the sensor unit 140 may include various types of sensors for recognizing the surroundings for autonomous driving. Representative examples may include a distance detection sensor or a proximity sensor 141 and a Lidar 141.

The proximity sensor 141 may include an ultrasonic sensor that recognizes nearby objects and determines the distance to the objects based on the time taken for emitted ultrasonic waves to return. A plurality of proximity sensors may be provided along the circumference, and may also be provided on an upper side to detect obstacles located on the upper side.

The Lidar 142 is a device that precisely expresses exterior appearances of the surroundings by emitting laser pulses and receiving the light that is reflected from the surrounding objects. The operation principle of the Lidar 142 is similar to that of a radar, but different electromagnetic waves are used in the Lidar 142 and the radar, so that the Lidar 142 and the radar are designed to use different technologies and different utilization ranges.

Lasers may damage human eyesight because they use light with a wavelength of 600 to 1000 nm. The Lidar 142 uses a longer wavelength than the lasers, and is used to measure not only the distance to a target object, but also a moving speed and direction, temperature, surrounding atmospheric material analysis, a concentration measurement, and the like.

In addition, the sensor unit 140 may include an illumination sensor, an acceleration sensor, a magnetic sensor, a gyro sensor, an inertial sensor, an RGB sensor, an infrared (IR) sensor, a fingerprint recognition sensor, an ultrasonic sensor, a light sensor, an optical sensor, etc.

The output unit 150 may generate various output signals related to visual, auditory and/or tactile sensations. The output unit 150 may include an optical output unit that outputs visual information, a display 151, etc. The output unit 150 may include a speaker 152 for outputting auditory information, an ultrasonic output unit for outputting ultrasonic signals belonging to an inaudible frequency, etc., and a haptic module for outputting tactile information.

The memory 185 may store data that supports various functions of the driving robot 100. The memory 185 may store not only a plurality of application programs (or applications) driven by the driving robot 100, but also data and commands required to operate the driving robot 100.

In addition, the memory 185 may store information required to perform operations using artificial intelligence, machine learning, and artificial neural networks. The memory 185 may store a deep neural network model. The deep neural network model may be used to infer a result value for new input data rather than learning data, and the inferred value may be used as a basis of determination required to perform a certain operation.

The power-supply unit 190 may receive external power or internal power under control of the controller 180, such that the power-supply unit 190 may supply the received power to the constituent components included in the driving robot 100. The power-supply unit 190 may include, for example, a battery. The battery 191 may be implemented as an embedded battery or a replaceable battery. The battery may be charged by a wired or wireless charging method, and the wireless charging method may include a magnetic induction method or a magnetic resonance method.

The driving unit 170 is a means for moving the driving robot 100, may include wheels or legs, and may include a wheel driving unit and a leg driving unit for controlling the wheels or legs.

A plurality of wheels provided on the bottom surface of the wheel driving unit may be controlled to move the driving robot 100 including the body. The wheels may include a main wheel 171 for fast driving, a caster 173 for changing the direction to another direction, and an auxiliary caster for stable driving so that the loaded articles (L) do not fall during driving.

The leg driving unit (not show) may control multiple legs according to control of the controller 180, and may thus move the body. The plurality of legs may correspond to a configuration formed so that the driving robot 100 can walk or run. The plurality of legs may be implemented as four legs, but the scope of the present disclosure is not limited thereto. The plurality of legs may be coupled to the body to be integrally formed, and may be implemented to be detachably coupled to the body.

The driving robot 100 may move the body through the driving unit 170 having at least one of the wheel driving unit and/or the leg driving unit. However, in this specification, an example in which the wheel driving unit is mounted on the driving robot 100 will be mainly described.

The controller 180 is a module that controls the configurations of the driving robot 100. The controller 180 may refer to a data processing device embedded in hardware that has a physically structured circuit to perform a function expressed by code or commands included in a program. As an example of the data processing device embedded in hardware, this exemplary data processing device may include processing devices such as a microprocessor, a central processing unit (CPU), a processor core, a multiprocessor, an ASIC, and an FPGA, but the scope of the present disclosure is not limited thereto.

For example, the controller 180 may collect the above information through the input unit 120. The input of the input unit 120 may also include a touch input on the display.

Based on the collected information, the controller 180 may transmit information on the articles (L) loaded in the loading area 50 to the mobile terminal 200 (see FIG. 1) through the communication unit 110.

Referring to FIG. 3, the robot control system 200 may include an artificial intelligence (AI) server. The AI server may mean a device that uses a machine learning algorithm to train an artificial neural network or uses a trained artificial neural network. Here, the robot control system 200 may include a plurality of servers to perform distributed processing, and may be defined as a 5G network. At this time, the AI server may be included as a part of the configuration of the driving robot 100, and may also enable the driving robot 100 to perform at least a part of the AI processing.

The robot control system 200 may include a communication unit 210, a memory 230, a learning processor 240, a processor 260, etc.

The communication unit 210 may transmit and receive data to and from an external device such as the driving robot 100.

The memory 230 may include a model storage unit 231. The model storage unit 231 may store a learning or learned model (or an artificial neural network 231a) through the learning processor 240.

The learning processor 240 may train (or lean) the artificial neural network 231a using training data (also called learning data). The learning model may be used while being loaded into the robot control system 200 of the artificial neural network, or may be loaded into an external device such as the driving robot 100 and then used.

The learning model may be implemented as hardware, software, or a combination of hardware and software. If all or some of the learning model are implemented as software, one or more commands constituting the learning model can be stored in the memory 230.

The processor 260 may infer a result value for new input data using the learning model, and may generate a response or control command based on the inferred result value.

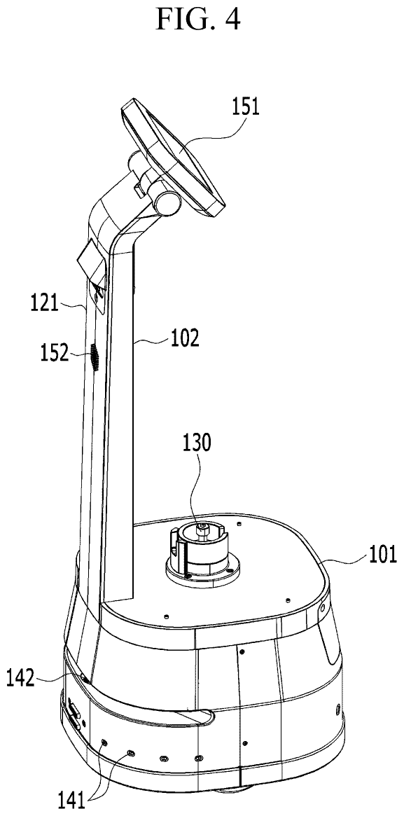

FIG. 4 is a perspective view illustrating the driving robot 100 according to an embodiment of the present disclosure. The driving robot 100 according to the present disclosure may move through the driving unit 170 located at the bottom of the body 101. Since the main body of the driving robot 100 has a box-shaped form and there is no area for loading articles, the body 101 may have a flat shape as long as only some components such as the driving unit 170, battery as the power-supply unit 190, and board assembly as the control unit 180 can be seated therein.

However, for convenience of use, the display 151 may be placed at a position spaced apart from the upper side of the body 101 through a vertical bracket 102 in consideration of the eye height of the user. The display 151 may include a touch sensor to function as an input unit, and the user may input a destination and change the function settings of the driving robot 100 through the display 151.

Although the driving robot in the drawing is shown in a form of a transport robot for transporting by coupling a trailer to a rear side thereof, it may not necessarily be limited thereto and may include all of a transport robot including a loading space by itself, a serving robot, and the like.

The driving robot according to the present embodiment may include a camera 121 positioned at a predetermined height, and the camera 121 may be implemented as a pair of cameras including a first camera facing the front and a second camera located obliquely downward.

A speaker 152 may be further provided to provide a warning sound or notification to the user and may be located on the vertical bracket 102 in consideration of the position of the user's ears.

The Lidar 142 and the proximity sensor 141 may be located in the body 101. Since the Lidar has a wide sensing range, a long groove may be included in the horizontal direction as shown in FIG. 4 to expand the sensing range of the Lidar 142.

The proximity sensor 141 may be implemented as multiple numbers that are arranged along the circumference of the body 101 to precisely detect the position.

The sensor such as the Lidar 142 or the proximity sensor 141 becomes a source for recognizing an obstacle located ahead to build a new map or recognizing an obstacle that is not present on the map to generate a new travel path.

However, because the Lidar 142 performs searching in a horizontal direction, it may not recognize an obstacle (e.g., a fork of a forklift truck and a pallet without a load) located low on a floor surface. The proximity sensor may have a low recognition rate when a recognition distance is short and a travel speed is high.

When the Lidar 142 is disposed at various vertical levels or a 3D lidar is used to increase the recognition rate, obstacles at the various vertical levels may be recognized, but there is a problem of cost increase. Accordingly, the present disclosure provides an obstacle recognition method for recognizing the obstacle by processing an RGB image captured by an RGB camera 121.

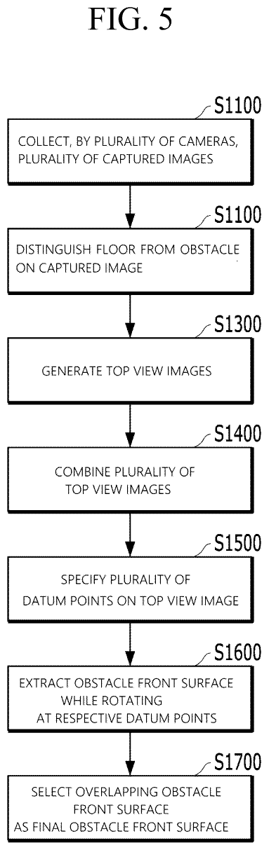

FIG. 5 is a flowchart according to an embodiment of an obstacle recognition method of the present disclosure. First, a plurality of captured images 11 and 12 are collected from a plurality of cameras 121a and 121b (S1100).

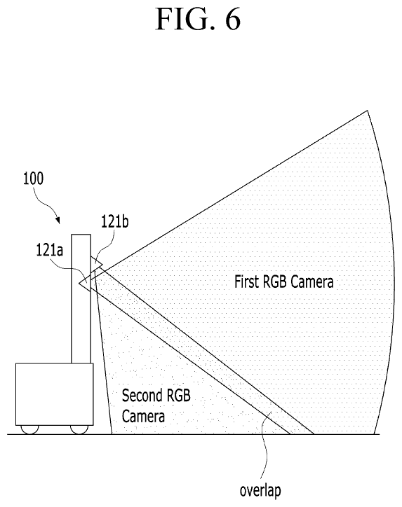

FIG. 6 is a view illustrating capturing ranges of the cameras 121a and 121b according to an embodiment of the driving robot of the present disclosure. FIG. 5 is a diagram illustrating the captured images 11 and 12 captured by the cameras 121a and 121b according to an embodiment of the driving robot of the present disclosure.

The cameras 121a and 121b of the present disclosure refer to cameras that capture general RGB images (visible light images) except for an infrared camera or a depth camera that measures a distance. A wide-angle camera may be used to widen a viewing angle of the camera.

When the wide angle is used, a wide range may be captured, so that an image of a sufficient size may be obtained with a single camera. However, in the case of a wide angle, a degree of distortion of an outer periphery is severe, so that it is difficult to obtain a top view image using inverse perspective mapping (IPM) to be described later.

Therefore, as shown in FIG. 5, a first camera 121a for capturing an area located ahead and a second camera 121b for capturing an area located below may be included. Hereinafter, the two captured images 11 and 12 obtained using the two cameras will be described, but there may be a single captured image or three or more captured images.

Accordingly, when the single camera is used, step S1100 in FIG. 5 may be replaced with a step of collecting a single captured image 11 and 12 from the single camera.

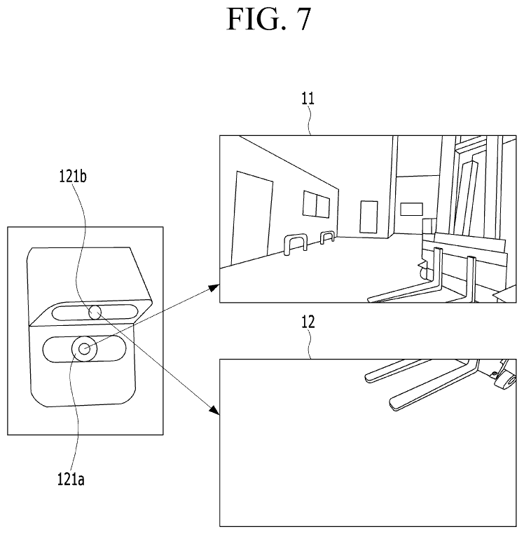

As illustrated in FIGS. 6 and 7, a first captured image 11 obtained by the first camera 121a for capturing the area located ahead may obtain an image of an area at a long distance, and a second captured image 12 obtained by the second camera 121b for capturing the area located below may obtain an image of a floor at a short distance.

Angles of view of the cameras 11 and 12 and an arrangement of the cameras 11 and 12 may be determined such that the two captured images 11 and 12 include a partially overlapping area.

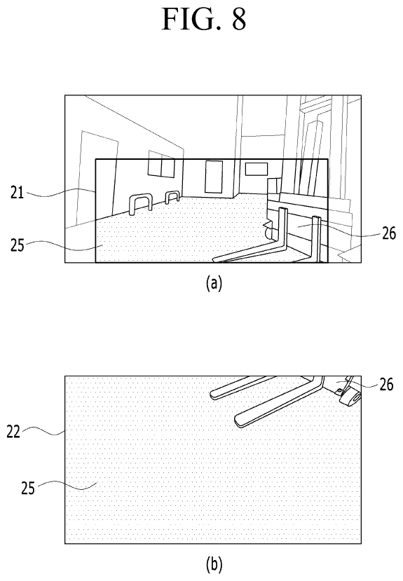

The floor and the obstacle may be distinguished from the captured images 11 and 12 (S1200). FIG. 8 is a diagram illustrating an image obtained by extracting a free space 25 of the floor from the captured images 11 and 12 in FIG. 7.

Because the second captured image 12 captured by the second camera 121b includes the floor as a whole, an entirety 22 thereof may be used as shown in (b) in FIG. 8. However, the first image 11 captured by the first camera 121a may be used by cutting only an area 21 including the floor as shown in (a) in FIG. 8.

In this regard, a width of the portion 21 cut from the first captured image 11 may be determined in consideration of a width of the second captured image 12. That is, a horizontal width of the portion 21 cut from the first captured image 11 may be determined such that an area with a horizontal width equal to or greater than a horizontal width of the second captured image 12 is included.

Image analysis for extracting the floor area 25 may perform distinguishing using a deep learning image segmentation technique. Learning for distinguishing an obstacle 26 from the floor area 25 may be performed via a deep neural network (DNN) model.

Because the driving robot 100 of the present disclosure may be mainly used in a logistics center, machine learning for identifying and labeling an article on the traveling path may be performed using image data collected at the logistics center site.

When it is difficult to sufficiently collect 2D image data, a 3D virtual environment may be generated and a virtual 2D image may be generated based on the same, so that insufficient image data for learning may be generated in large quantities and thus the learning may be performed in a short time.

In particular, the different captured images 11 and 12 may be obtained based on angles of the cameras 121a and 121b, and thus the distinguishment between the floor area (the free space) 25 and the obstacle 26 becomes easier.

However, when a shadow, light reflection, sunlight reflection, floor contamination, and the like on the floor are captured in the captured images 11 and 12, they may be mistaken for the obstacles even when they are not the obstacles.

To prevent such misrecognition, image boundaries of the shadow, the light reflection, the sunlight reflection, the floor contamination, and the like may be blurred via a smoothing technique that reduces rapid changes in the captured images 11 and 12. By applying the smoothing technique, the problem of misrecognizing the light reflection, the sunlight reflection, the floor contamination, and the like as the obstacles may be solved.

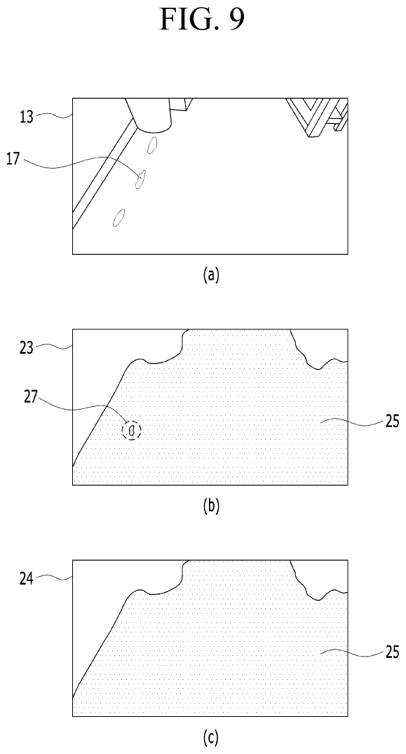

FIG. 9 is a view illustrating a hole filter technique for removing a portion misrecognized as an obstacle from a captured image 13 according to an embodiment of an obstacle recognition method of the present disclosure.

Even when shading of the floor, which is a factor of the misrecognition, is reduced by smoothing the captured image 13, the strong light reflection or the like still shows a difference at the floor, and thus is able to be recognized 27 as an obstacle as shown in (b) in FIG. 9.

When a size of an area recognized as the obstacle is smaller than a specified value, it may be determined as the misrecognition, and the hole filter for removing such area may be applied as shown in (c) in FIG. 9. The specified value of the hole filter may be set by a user or may be determined in consideration of a size of an obstacle present in a place where the driving robot 100 is located, such as the logistics center.

The hole filter may be applied in the step S1200 of extracting the floor area, or may be applied on top view images 31, 32, and 33 after a next step (S1300) of generating the top view images.

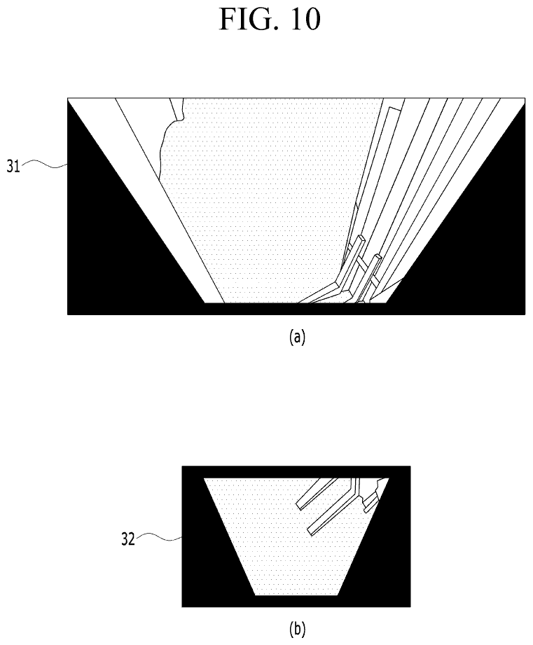

FIGS. 10 and 11 are diagrams illustrating a process of generating the top view images 31, 32, and 33 according to an embodiment of an obstacle recognition method of the present disclosure.

As shown in FIG. 10, the captured images may be converted to the top view images 31, 32, and 33 by removing a perspective (S1300). A method for obtaining the top view images 31, 32, and 33 may use inverse perspective mapping (IPM). The inverse perspective mapping is a method of removing a perspective effect of the general RGB camera and performing re-mapping on a 2D domain.

Although the horizontal lengths of the captured images 11 and 12 are equal to each other, because a wider area is represented at the long distance than at the short distance, the top view images 31 and 32 may be converted into inverted trapezoidal images as shown in (a) and (b) in FIG. 10.

Because the first captured image 11 captures the area at a greater distance compared to the second captured image 12, the first top view image 31 may be longer than the first captured image 11.

A second top view image 32 of the second captured image 12 may be smaller than the second captured image 12. The first captured image 11 may be generated as a top view image 31 based on a horizontal width at a lower end thereof, and the second captured image 12 may be generated as the top view image 32 based on a horizontal width at an upper end thereof.

As shown in FIG. 11, a top view image 33 may be completed by combining the first top view image 31 and the second top view image 32 converted as such (S1400). When the single captured image 11 and 12 is obtained with the single camera, only the single top view image may be obtained, so that the S1400 process may be omitted.

However, the top view image 33 may cause an error of recognizing an article that is vertically standing in the captured images 11 and 12 as an obstacle wide in the horizontal direction. Short distance information is accurate, but in case of a long distance, because of a tall obstacle, the top view image 33 in which the obstacle is located in a place where there is no actual obstacle may be generated.

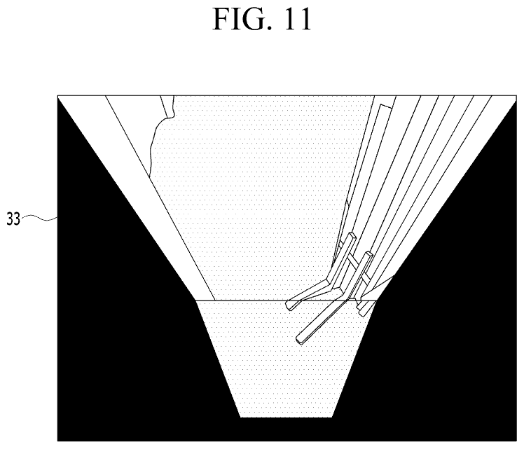

FIG. 12 is a diagram illustrating an image in which the top view image 33 according to an embodiment of an obstacle recognition method of the present disclosure is divided into an obstacle and a floor and reflected in a map. (b) in FIG. 12 is a simplified segmentation map 50 in which a boundary line 56 of the obstacle and an empty floor 51 are distinguished from each other in the top view image 34 as shown in (a) in FIG. 12.

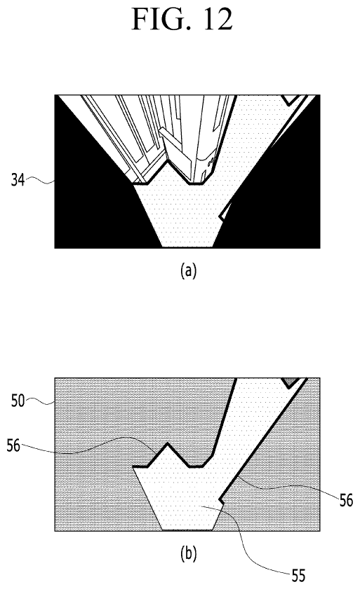

FIG. 13 is a map showing a state of an actual space. As shown in (a) in FIG. 13, a space is present at the rear of an obstacle 91 such as a forklift truck or a load. However, as shown in (b) in FIG. 12, the obstacle boundary 56 on the segmentation map 50 extracted from the top view image 34 extends rearward of the obstacle.

As shown in (b) in FIG. 13, when the obstacle boundary 56 extracted from the top view is reflected in an actual map 90 and indicated as a searched obstacle 93, it is reflected in the map 90 that a path for moving to a destination 95 is blocked, so that a path for the driving robot 100 to reach a destination 92 may be generated.

To solve such problem, a vision LiDAR technique S1500, S1600, and S1700 may be applied to distinguish the actual obstacle from the incorrectly reflected obstacle among the obstacles 56 extracted from the top view image 33.

The vision LiDAR is a method of searching on the top view image 33 by applying a method of searching surroundings while rotating at datum points 51 and 52 like the Lidar 142. It is not a method of using the actual Lidar 142, but a method of extracting the actual obstacle via linear search while rotating on the image.

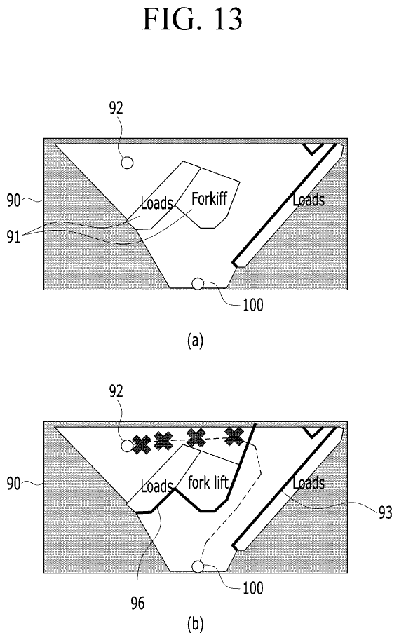

FIG. 14 is a diagram illustrating a method of extracting a front surface of an actual obstacle in a vision LiDAR method according to an embodiment of an obstacle recognition method of the present disclosure.

The obstacle boundary line 56 on the segmentation map 50 includes a surface on which the actual obstacle lies on the floor, but there is also a boundary line that is misrecognized as being placed on the floor during the top view conversion because of a vertical level of the obstacle. The vision LiDAR extracts the front surface of the actual obstacle, excluding the misrecognized boundary line from the obstacle boundary on the partition map.

The datum points 51 and 52 are selected at a location closest to a floor area 55 of the segmentation map 50 extracted from the top view image 33 (S1500). The closest location is a lower end of the floor area 55. Therefore, as shown in FIG. 14, the datum points may be located at a lower end side of the segmentation map image 50.

A plurality of datum points 51 and 52 may be extracted. Further, as the number of datum points 51 and 52 increases, accuracy increases. However, because a processing speed is lowered in the controller 180 of the driving robot 100 or the server, two datum points 51 and 52 may be used as shown in FIG. 14.

A distance between the pair of datum points 51 and 52 may increase as the segmentation map 50 increases, and the pair of datum points 51 and 52 may be arranged to be spaced apart from each other on left and right sides of a center of the segmentation map 50. This is to obtain more accurate values via the linear search at different locations.

The front surface of the obstacle is extracted via the linear search while rotating at the respective datum points 51 and 52 (S1600). When the obstacle boundary line 56 of the segmentation map 50 touches straight lines extending from the datum points 51 and 52 to an outer periphery of the segmentation map 50, it is recognized as the front surface of the obstacle.

A first datum point 51 and a straight line may be connected to each other by sequentially moving one or more pixels upward at a time starting from a point 50a at a lower left end of the segmentation map image. Along the outer periphery, the search is performed from the lower left end 50a to a lower right end 50d sequentially (50a->50b->50c->50d).

A straight line connecting the first datum point 51 with the point 53′ meets the obstacle boundary line 56 for the first time 53.

In FIG. 14, when straight lines connecting the first datum point 51 with the outer periphery do not touch the obstacle boundary line 56, they are not indicated on the drawing, and only the vertical search that meets the obstacle boundary line 56 is indicated.

At the second datum point 52, vertical search may be performed while drawing a straight line by sequentially moving one or more pixels upward at a time starting from the point 50a at the lower left end of the image of the segmentation map 50 in the same manner.

A portion overlapping the obstacle boundary line 56 during the linear search at the first datum point 51 and a portion overlapping the obstacle boundary line 56 during the linear search at the second datum point may partially coincide, but may partially diverge.

An obstacle front surface 57 searched at both the two datum points 51 and 52 may be determined and extracted as the actual obstacle front surface 57.

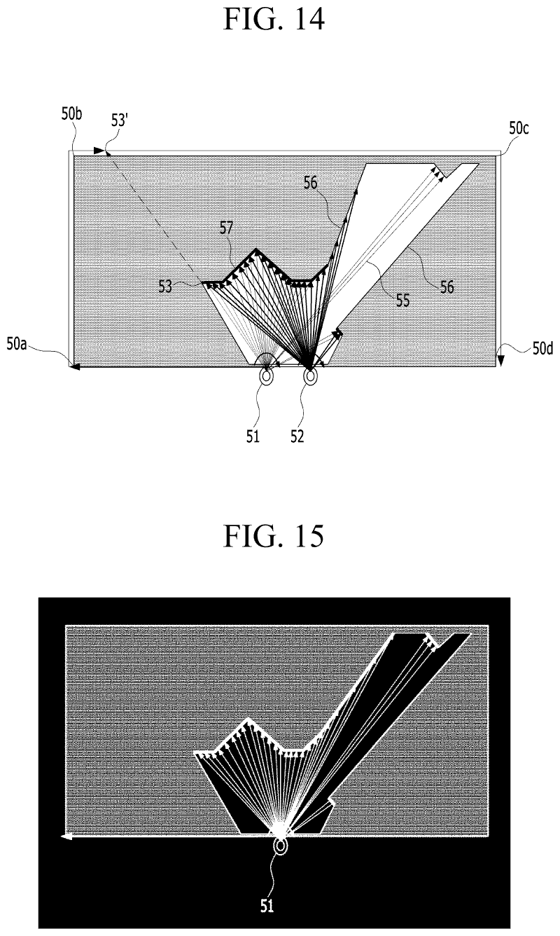

In this regard, when the number of datum points 51 and 52 is set to one, as shown in FIG. 15, a result almost identical to the obstacle boundary line extracted from the top view is obtained. Accordingly, as shown in FIG. 14, the linear search is performed using the two or more datum points 51 and 52, and only the overlapping result among the results searched at the respective datum points 51 and 52 is selected as the actual obstacle front surface 57 (S1700).

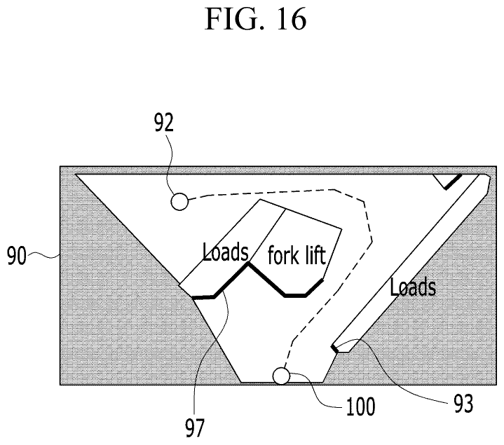

FIG. 16 is a diagram illustrating a state in which the extracted obstacle front surface 57 is reflected 97 in the map 90 according to an embodiment of an obstacle recognition method of the present disclosure. As illustrated in FIG. 16, when only the extracted actual obstacle front surface 57 is reflected 97 in the existing map, the obstacle that is misrecognized as being located on the traveling path may be removed, and thus the path to the destination may be designed.

A searchable range of such a vision LiDAR may vary depending on the location of the driving robot 100, so that the driving robot 100 may travel while periodically performing the vision LiDAR.

The vision LiDAR may replace the sensor such as the Lidar 142, or may search for the obstacle adjacent to the floor that the Lidar 142 sensor is not able to detect, so that the vision LiDAR may be additionally used together with other sensors.

According to the obstacle search method of the present disclosure, the obstacle located on the floor without having a high vertical level may be recognized.

Because the obstacle may be recognized at a lower cost than the sensor, it may be applied to various types of driving robots.

The above detailed description is not to be construed as limiting in any respect and should be considered exemplary. The scope of the disclosure is to be determined by a reasonable interpretation of the appended claims, and all changes within the equivalents of the disclosure are included in the scope of the disclosure.

1. A method for recognizing an obstacle, the method comprising:
receiving a captured image from a camera;
distinguishing a floor area from an obstacle on the captured image;
generating a top view image by removing perspective of the captured image;
specifying a plurality of datum points at the shortest distance on the top view image;
extracting an obstacle front surface by performing linear search while rotating at each of the plurality of datum points; and
selecting only an overlapping portion of the obstacle front surfaces extracted from the plurality of datum points as a final obstacle front surface.

2. The method of claim 1, wherein the extracting of the obstacle front surface includes:
connecting a straight line from each datum point to a pixel of an outer periphery of the top view image, and when the straight line overlaps an obstacle on the top view image, extracting the straight line as the obstacle front surface.

3. The method of claim 2, wherein the pixel of the outer periphery of the top view image includes pixels on lines extending from a lower left end to an upper left end, an upper right end, and then to a lower right end of the top view image.

4. The method of claim 1, wherein the plurality of datum points are distributed at least to a left side and a right side from a location of the camera.

5. The method of claim 1, wherein a spacing between the datum points is great when a size of the top view image is great, and is small when the size of the top view image is small.

6. The method of claim 1, wherein the specifying of the plurality of datum points includes:
generating a segmentation map obtained by extracting a boundary between a floor area and an obstacle from the top view image; and
specifying the plurality of datum points at a lower end of a floor area of the segmentation map.

7. The method of claim 1, wherein the camera includes:
a first camera configured to capture an area located ahead to provide a first captured image; and
a second camera configured to capture an area located below to provide a second captured image,
wherein the top view image is generated by synthesizing the first captured image and the second captured image after removing the perspective from each image.

8. The method of claim 7, wherein a lower portion of the first captured image overlaps an upper portion of the second captured image.

9. The method of claim 1, wherein the generating of the top view image includes:
converting the captured image into the top view image using an inverse perspective mapping (IPM) technique.

10. The method of claim 1, wherein the top view image is generated by discarding an upper portion not including the floor area of the captured image.

11. The method of claim 1, wherein the distinguishing of the floor area from the obstacle further includes:
removing a shadow and light reflection on the captured image.

12. The method of claim 1, further comprising:
adding the selected obstacle to an existing map or a map obtained via another sensor.

13. A driving robot comprising:
a main body including a driving structure;
a camera configured to capture an image in a travel direction; and
a controller configured to recognize an obstacle via the captured image captured by the camera and control the driving structure,
wherein the controller is configured to:
distinguish a floor area from the obstacle on the captured image;
generate a top view image by removing perspective of the captured image;
extract a plurality of datum points at the shortest distance on the top view image;
extract an obstacle front surface by performing linear search while rotating at each of the plurality of datum points;
select only an overlapping portion of the obstacle front surfaces extracted from the plurality of datum points as an actual obstacle, and add the selected obstacle to an existing map or a map obtained via another sensor;
set a traveling path based on the map with the selected obstacle added; and
control the driving structure to move along the traveling path.

14. The driving robot of claim 13, wherein the controller is configured to connect a straight line from each datum point to a pixel of an outer periphery of the top view image, and when the straight line overlaps an obstacle on the top view image, extract the straight line as the obstacle front surface.

15. The driving robot of claim 13, wherein the camera includes:
a first camera configured to capture an area located ahead to provide a first captured image; and
a second camera configured to capture an area located below to provide a second captured image,
wherein the top view image is generated by synthesizing the first captured image and the second captured image after removing the perspective from each image.
